(19) United States
(12) Patent Application Publication
(10) Pub. No.: US 2010/0092868 A1
(43) Pub. Date: Apr. 15, 2010

(54) CARBON NANOTUBE-COATED SILICON/METAL COMPOSITE PARTICLE, PREPARATION METHOD THEREOF, AND ANODE FOR SECONDARY BATTERY AND SECONDARY BATTERY USING THE SAME

(76) Inventors: Hyung-Sun KIM, Seoul (KR); Byung Won CHO, Seoul (KR); Kyung Yoon CHUNG, Seoul (KR); Joong Kee LEE, Seoul (KR); Won Il CHO, Seoul (KR)

Correspondence Address: OSTROLENK FABER GERB & SOFFEN, 1180 AVENUE OF THE AMERICAS, NEW YORK, NY, 100368403, US

(21) Appl. No.: 12/578,030

(22) Filed: Oct. 13, 2009

(30) Foreign Application Priority Data
Oct. 14, 2008 (KR) 10-2008-0100811

(51) Int. Cl. H01M 4/583; H01M 4/88; B05D 5/12

(52) U.S. Cl. 429/231.8; 252/182.1; 427/122; 977/721; 977/948

(57) ABSTRACT

Disclosed are a carbon nanotube-coated silicon/metal composite particle, a preparation method thereof, an anode for a secondary battery comprising the carbon nanotube-coated silicon/metal composite particle, and a secondary battery comprising the anode, wherein the carbon nanotube-coated silicon/metal composite particle characterized in comprising: a composite particle of silicon and metal; and a carbon nanotube coated on the surface of the composite particle of silicon and metal, wherein the carbon nanotube-coated silicon/metal composite particle may be prepared by preparing composite particle of silicon and metal, followed by treating the composite particles of silicon and metal with heat under a mixed gas atmosphere of an inert gas and a hydrocarbon gas.

### TECHNICAL FIELD

The present invention relates to a carbon nanotube-coated silicon/metal composite particle, a preparation method thereof, and an anode for a secondary battery and a secondary battery using the composite particle.

### BACKGROUND ART

Typically, a secondary battery, capable of being charged and discharged, has been widely used in the field of high-tech electronic machinery, such as cellular phones, notebook computers, camcorders, and the like. Particularly, the use of a lithium secondary battery has been spreading fast due to its high operating voltage of 3.6V and high energy density per unit weight.

The secondary battery comprises a cathode, an anode and an electrolyte. Especially, the performance of the secondary battery depends largely on an anode active material.

In a carbonaceous material, commercially used as an anode active material, one lithium atom is theoretically intercalated per six carbon atoms, by which its theoretical maximum capacity is limited to 372 mAh/g, which results in limitation on increase in its capacity.

A silicon, another anode active material, has a theoretical maximum capacity of 4200 mAh/g which is far superior to those of carbonaceous materials. However, silicon suffers from a considerably large volumetric change (i.e., 200 to 350%) which is caused by its reaction with lithium during charging and discharging. Consequently, during continuous charging and discharging processes, the anode active material may be separated from a collector, or a resistance increases due to the change in contact interfaces between the anode active materials, which results in deterioration of cycle characteristics of batteries.

In order to overcome such drawbacks of the silicon electrode material, various methods, for example, a method for preparing an anode material by mixing graphite particles with silicon particles or lithium powders (U.S. Pat. No. 5,888,430), a method for mixing silicon particles, which were prepared by micronizing common silicon powder under a nitrogen atmosphere, with graphite (H. Uono et al., Mitsubishi Chemical Group and Keio Univ., Japan), a method for preparing an amorphous Si—C—O anode material by a sol-gel method (T. Morita, Power Supply & Devices Lab., Toshiba Co., Japan) and the like, have been proposed.

However, those methods adopt complicated processes for preparing electrodes, and electrical conductivities of the prepared electrodes are not high enough to satisfy a high charge and discharge rate. In addition, it is difficult to control the structural change of the electrodes resulting from the volumetric change of the active materials during continuous charging and discharging, and the electrode are easily separated from the active materials and the collector. Therefore, there are still remaining problems of decrease in capacities and cycle performances of batteries.

### DISCLOSURE OF THE INVENTION

### Technical Problems to be Solved

Therefore, the present invention is to overcome the drawbacks of the related art, its object is to provide an electrode material (i.e., an electrode active material) which can prevent large volumetric change, acting as a big problem in commercial use of a silicon electrode material, during charging and discharging, improve electrical conductivity of silicon, and also to provide a preparation method thereof.

Another object of the present invention is to provide an electrode material having characteristics of high output, high capacity and prolonged life, and a secondary battery comprising such electrode material.

Still another object of the present invention is to provide an electrode is material which can prevent a solid electrolyte interface (SEI) membrane formation caused by the reaction of silicon with an electrolyte, and that the portion of the electrode material in contact with the electrolyte is formed of a material with no reactivity with the electrolyte, thereby preventing gas generation resulting from decomposition of electrolyte, and to provide a preparation method thereof.

Still another object of the present invention is to provide a method for mass production of a negative electrode material in an eco-friendly, simple and economical manner.

### SUMMARY OF THE INVENTION

The above and other objects of the present invention are achieved by the technical means as described below.

(1) A carbon nanotube-coated silicon/metal composite particle, comprising a composite particle of silicon and metal; and a carbon nanotube coated on the surface of the composite particle of silicon and metal.

(2) A preparation method of a carbon nanotube-coated silicon/metal composite particle comprising: (a) preparing a composite particle of silicon and a metal; and (b) treating the composite particle prepared in step (a) with heat under a mixed gas atmosphere of an inert gas and a hydrocarbon gas, to form a coating of a carbon nanotube on the surface of the composite particle.

(3) An anode for a secondary battery, comprising: a collector; and an anode active material comprising the carbon nanotube-coated silicon/metal composite particle of (1) above, which is applied on at least one side of the collector.

(4) A secondary battery, comprising: the anode of (3) above; a cathode; and an electrolyte.

### BRIEF DESCRIPTION OF THE DRAWINGS

FIG. 1 is a transmission electron microscopic (TEM) image of the carbon nanotube-coated silicon/copper particle prepared in Example 1 of the present invention;

FIG. 2 is a curve showing charge and discharge characteristics of a battery comprising the carbon nanotube-coated silicon/copper alloy electrode material prepared in Example 1 of the present invention and a lithium metal electrode;

FIG. 3 is a curve showing charge and discharge characteristics of the battery prepared in Example 2 of the present invention, comprising the carbon nanotube-coated silicon/copper/graphite composite electrode material; and a lithium metal electrode;

FIG. 4 is a graph for the comparison of cyclic performance between the carbon nanotube-coated silicon/copper/graphite composite electrode material prepared in Example 2 of the present invention and a pure natural graphite electrode prepared in Comparative Example 2;

FIG. 5 is a TEM image of the carbon nanotube-coated silicon/copper particle prepared in Example 3 of the present invention by plating copper on a nano-sized silicon particle, followed by carrying heat-treatment;

FIGS. 6a and 6b are curves respectively showing charge and discharge characteristics and cycle performance of the battery prepared in Example 3, comprising: the carbon nanotube-coated silicon/copper/graphite composite electrode material according to the present invention which was prepared by plating copper on a silicon particle, followed by carrying out heat-treatment; and a lithium metal electrode;

FIGS. 7a and 7b are graphs respectively showing charge and discharge characteristics and cycle performance of the battery, comprising a silicon/copper/graphite composite electrode material not containing carbon nanotube coating, which was prepared in Comparative Example 1 by plating copper on a silicon particle, followed by carrying out heat-treatment; and a lithium metal electrode.

### DETAILED DESCRIPTION OF THE PREFERRED EMBODIMENTS

The present invention provides a carbon nanotube-coated silicon/metal composite particle, comprising a composite particle of silicon and metal; and a carbon nanotube coated on the surface of the composite particle of silicon and metal.

The composite particle of silicon and metal may be a silicon-metal alloy particle in the form of a compound of silicon and metal particle, or a particle in which a metal is deposited on silicon particle by electroless plating, but not limited thereto.

The metal contained in the composite particle of silicon and metal prevents from volumetric change during charging and discharging, enhances an electrical conductivity, and serves as a catalyst for aiding growth of the carbon nanotube on the surface of the composite particle. The metal may be selected from the group consisting of phosphorous, magnesium, calcium, aluminum, titanium, copper, nickel, iron, chrome, manganese, cobalt, vanadium, tin, indium, zinc, gallium, germanium, zirconium, molybdenum and antimony. The present invention is described with copper as an example of the metal.

The ratio of the silicon to the metal in the composite particle of silicon and metal is preferably 5:95 to 95:5 by weight. For example, the ratio of silicon to metal may be 95:5, 90:10, 80:20, 70:30, 60:40, 50:50, 40:60, 30:70, 20:80, 10:90 or 5:95 by weight.

The carbon nanotube grows using the metal component contained in the composite particle of silicon and metal as a catalyst. The thickness of the carbon nanotube coated on the surface of composite particle of silicon and metal is preferably in the range of 1 to 20 nm. If the thickness is less than 1 nm, it is difficult to expect the improvement of electrical properties of the silicon particle. If the thickness exceeds 20 nm, it rather increases costs with no further improvement of electrical properties in proportion to the thickness.

Silicon, which is typically used as an anode active material for a secondary battery, is reactive with an electrolyte on the surface of the anode active material at the time of initial cycle charging, which result in forming a solid electrolyte interface (SEI) membrane having a low electrical conductivity, by which resistance is increased, so as to cause deterioration of battery performances, such as cycle performance, lifetime, charge and discharge efficiency, high rate capacity, and the like.

However, if the carbon nanotube-coated silicon/metal composite particle according to the preset invention is used as an anode active material for a secondary battery, SEI membrane formation at the time of the initial charging is prevented, by which excellent electrical conductivity can be maintained with stability, because carbon nanotube having an excellent electrical conductivity and is not reactive with electrolyte is coated on the surface of the silicon/metal composite particle.

If a layer in contact with an electrolyte reacts with the electrolyte, the electrolyte is decomposed to generate gas, which induces internal pressure inside the battery, thereby causing a problem such as an electrolyte leakage. However, in the present invention, the occurrence of such problems can be minimized because the carbon nanotube is not reactive with electrolytes.

A method for preparing a carbon nanotube-coated silicon/metal composite particle according to the present invention comprises (a) preparing a silicon/metal composite particles, (b) treating the composite particles with under a mixed gas atmosphere of an inert gas and a hydrocarbon gas, to form carbon nanotube on the surface of the composite particles of silicon and metal.

In Step (a), the composite particle of silicon and metal may be prepared by mixing silicon particles with the metal particles, followed by milling the resulting mixture. For example, micro-sized silicon particles and copper particles are ball-milled under an argon atmosphere at 400 rpm for 5 hours, and the resulting mixture are alloyed by a wet milling in ethanol for 5 hours, thereby obtaining the composite particles.

Alternatively, the composite particles of silicon and metal may be prepared by a electroless plating of metal on the surface of silicon particles. For example, electroless copper plating may be performed on silicon particles in an average size of 60 nm. A plating solution may comprise 4 g/l of copper sulfate as a metallic salt, 60 g/l of EDTA2Na as a chelating agent, 60 mg/l of NaCN as a stabilizer, and 5% NaOH as a pH adjusting agent. Plating is carried out at 30° C. using 30 ml/l of 40% formalin as a reducing agent. The plating may be carried out by adding 4.5 g of silicon particles in size of 60 nm to 450 ml of the plating solution, followed by uniformly dispersing the resultant for 20 minutes, to which NaOH solution was added to maintain at pH 11. When 10 ml of formalin solution is added, 10% by weight of copper is plated on the surface of the nano-sized silicon particle. The resultant solution is then filtrated, and the residue is washed with distilled water, to obtain copper-plated silicon particles.

In Step (b), the composite particles of silicon and metal prepared in Step (a) are treated with heat under a mixed gas atmosphere of an inert gas and a hydrocarbon gas. The hydrocarbon gas is thermally decomposed and then carbonized, to form a carbon nanotube on the surface of the composite particles of silicon and metal. The carbon nanotube coated on the surface of the composite particles of silicon and metal improves electrical conductivity and mechanical stability of the silicon particles, and remarkably reduces volume expansion rate of the silicon particles during continuous charge and discharge.

The mixed gas may be a mixture of argon or nitrogen gas with propylene or butylene gas. The content of the hydrocarbon gas is preferably 5 to 50% of the total weight of the mixed gas. In case that the hydrocarbon gas content is in this range, it facilitates the adjustment of the thickness of the carbon nanotube formed to on the surface of the composite particles of silicon and metal. If the content beyond this range, it is difficult to adjust the thickness of the carbon nanotube to 1 to 20 nm.

The heat is treated preferably at a temperature range of 400 to 900° C. for 1 to 24 hours, which allows the carbon nanotube to be compactly coated on the surface of the composite particles of silicon and metal. More preferably, a multi-step heat treatment is carried out in such a manner that heat is treated at 350° C. for 3 hours, followed by raising the temperature at 1 to 10° C./min, preferably, at a 5° C./min up to 600 to 900° C. Upon treating heat under this condition, the hydrocarbon is sufficiently decomposed, and then uniformly coated on the surface of the composite particle of silicon and metal as a pure carbon nanotube.

For example, the heat treatment of Step (b) may be carried out by the procedures described in detail below.

First, the composite particles of silicon and metal prepared in Step (a) are put into an alumina crucible, which is put into a tubular furnace. A mixed gas of an inert gas and a hydrocarbon gas, for example, a mixture of argon containing 10% by weight of propylene gas, is introduced into the tubular furnace for 1 hour before the heat treatment, so as to establish an inert atmosphere inside the furnace. This is to remove oxygen inside the tubular furnace, so as to previously establish an inert atmosphere, so as to make the hydrocarbon gas be completely carbonized without being oxidized during the heat treatment.

Next, the composite particles, for example, silicon/copper alloy particles or copper-plated silicon composite particles are then treated with heat at 700° C. for 10 hours under a mixed gas atmosphere, so as to carbonize the hydrocarbon gas onto the surface of the composite particles. The resulting particles are allowed to cool to room temperature. the heat-treated particles are then milled in a mortar, and then sifted through a 200 to 270 mesh sieve, thereby obtaining uniform carbon nanotube-coated silicon/copper composite particles. In such a manner, in the present invention, a hydrocarbon is uniformly carbonized on the surface the composite particles so as to form highly conductive carbon nanotubes with no reactivity on the surface of the composite particles, by which SEI membrane formation can be prevented and conductivity can be enhanced, thereby obtaining carbon nanotube-coated silicon/copper composite particles having improved capacity, cycle characteristics and a prolonged life.

The present invention also provides an anode for a secondary battery, comprising a collector; and an anode active material, comprising the carbon nanotube-coated silicon/copper composite particles according to the present invention, which is applied on at least one side of the collector.

The anode active material may further comprise graphite, in addition to the carbon nanotube-coated silicon/copper composite particle. In this case, it is preferred that the ratio of the composite particle to graphite is in the range of 5:95 to 95:5 by weight. For example, the ratio of the composite particle to graphite may be 5:95, 10:90, 20:80, 30:70, 40:60, 50:50, 60:40, 70:30, 80:20, 90:10 or 95:5 by weight. Either a natural graphite or an synthetic graphite may be used as graphite.

For example, the anode for a secondary battery according to the present invention may be fabricated by the procedures described in detail below.

First, a composite of the carbon nanotube-coated silicon/copper composite particles with graphite is used as an electrode material (i.e., an anode active material), and 1 wt. % aqueous carboxymethyl cellulose (hereinafter referred to as “CMC”) solution and 40 wt. % aqueous styrene butadiene rubber (hereinafter referred to as “SBR”) solution are used as a binder. The electrode material and the solutions are mixed and homogenized. It is preferred that 50 to 90% by weight of the electrode material and 10 to 50% by weight of the binder are used. In some cases, a conductive agent, such as carbon black, may further be added. In this case, 50 to 90% by weight of the electrode material, 5 to 30% by weight of the conductive agent, and 5 to 50% by weight the binder are used so that the total ratio becomes 100% by weight. In order to produce a slurry having an appropriate viscosity, i.e., 1000 to 3000 centi-poise, the aqueous CMC solution may be used with one to three folds. In order to homogenize, the slurry is stirred at 3,000 rpm for 15 minutes using a homogenizer.

Next, the homogenized slurry is deposited on a 10 μm thick copper foil, which is used as an anode collector, in the thickness of, for example, 50 to 200 μm with a doctor blade method, thereby obtaining an anode for the secondary battery according to an embodiment of the present invention.

The present invention also provides a secondary battery, comprising the anode according to the present invention; a cathode; and an electrolyte.

The secondary battery according to the present invention can prevent SEI membrane formation and gas generation due to electrolyte decomposition, because the carbon nanotube of the carbon nanotube-coated silicon/metal composite particle, used for an anode active material, has no reactivity with an electrolyte.

### Example

Hereinafter, the present invention will be described in more detail with examples. However, the examples are merely given to help understanding the present invention more obviously, and not to limit the scope of the present invention thereto. The present invention should be construed within its scope as defined in the appended claims.

### Example 1

4.75 g of silicon particles in an average size of 1 μm and 0.25 g of copper particles in an average size of 3 μm were ball-milled at 400 rpm for 5 hours under an argon atmosphere, and alloyed in ethanol with wet milling. The alloyed particles were put into a crucible inside a tubular furnace, which was treated with heat at 700° C. for 10 hours under an atmosphere of a mixed gas consisting of 90% by weight of argon and 10% by weight of propylene, and then allowed to cool to room temperature. In order to prevent oxidation, the mixed gas containing 90% by weight of argon and 10% by weight of propylene was introduced at least one hour before the heating, so as to remove oxygen. The heat-treated particles were sifted through a 200 mesh sieve, to obtain uniform particles of carbon nanotube-coated silicon-copper alloy particles.

1.87 g of the prepared carbon nanotube-coated silicon-copper alloy particles as an anode active material, 0.187 g of carbon black as a conductive agent, and 4 g of 0.1 wt. % aqueous CMC solution and 0.25 g of 40 wt. % SBR solution as a binder were mixed to obtain a slurry. The viscosity of the slurry was adjusted to 1,000 centi-poise, at which the slurry was easily coated on a copper foil, and then the slurry was stirred with a mixer at 3,000 rpm for 15 minutes. The slurry was then coated on 100 μm thick copper foil with the thickness of 10 μm with a doctor blade method, to produce an anode which comprises carbon nanotube-coated silicon-copper composite particles as an electrode material. The anode was cut into a predetermined size (e.g., 3×4 cm), and then dried in a vacuum oven at 80° C. for 24 hours.

The anode and a lithium metal cathode were stacked together with a 20 μm thick polypropylene (PP) separator, which was interposed between the anode and the cathode, to which an electrolytic solution, in which 1M LiPF₆ was dissolved in an organic solvent consisting of ethyl carbonate, ethyl methyl carbonate and dimethyl carbonate in a volumetric ratio of 1:1:1 was injected. A battery was assembled in a dry room (temperature of dew point: −50°) using an aluminum pouch, and its charge and discharge characteristics, and cycle characteristics were evaluated.

### Example 2

1.5 g of the carbon nanotube-coated silicon/copper alloy particles prepared in Example 1 and 3.5 g of natural graphite as an anode active material, 0.25 g of carbon black as a conductive agent, and 8 g of 0.1 wt. % aqueous CMC solution and 0.25 g of 40 wt. % aqueous SBR solution as a binder were mixed to obtain a slurry. The viscosity of the slurry was adjusted to 1,000 centi-poise, at which the slurry was easily coated on a copper foil, and the slurry was then stirred with a mixer at 3000 rpm for 15 minutes. The slurry was then coated on 100 μm thick copper foil with the thickness of 10 μm with a doctor blade method, to produce an anode comprising a mixture of the carbon nanotube-coated silicon/copper composite particles and graphite. The anode was cut into a predetermined size (3×4 cm), and dried in a vacuum oven at 80° for 24 hours. A battery was assembled using the prepared anode in the manner as described in Example 1, and its charge and discharge characteristics, and cycle characteristics were then examined.

### Example 3

A electroless copper plating was carried out on silicon particles in an average size of 60 nm as follows: A plating solution comprises 4 g/l of copper sulfate as a metallic salt, 60 g/l of EDTA2Na as a chelating agent, 60 mg/l of NaCN as a stabilizer and 5% of NaOH as a pH adjusting agent. 40% formalin solution in an amount of 30 ml/l was used as a reducing agent. The plating was carried out at 30° C. 4.5 g of silicon particles in size of 60 nm were added to 450 ml of the plating solution, and uniformly dispersed for 20 minutes. NaOH solution was added to the uniformly dispersed plating solution, so as to maintain at pH 11. 10 ml of the formalin solution was then added so that 10% by weight of copper was plated on the surface of the nano-sized silicon particles. The resultant solution was filtrated, and the particles were washed with distilled water, to yield copper-plated silicon particles, which was then treated with heat in the manner as described in Example 1.

0.5 g of the prepared carbon nanotube-coated silicon-copper composite particles and 4.5 g of natural graphite both used as an anode material, 0.25 g of conductive agent, 7.5 g of 0.1 wt. % aqueous CMC solution and 0.25 g of 40 wt. % aqueous SBR solution as a binder were mixed, so as to obtain a slurry. The viscosity of the slurry was adjusted to 1,000 centi-poise, at which the slurry was easily coated on a copper foil, and the slurry was then stirred with a mixer at 3000 rpm for 15 minutes. The slurry was then coated on 100 μm thick copper foil with the thickness of 10 μm with a doctor blade method, to product an anode comprising the carbon nanotube-coated silicon/copper composite particles and graphite. A battery was assembled using the prepared anode in the manner as described in Example 1, and its charge and discharge characteristics, and cycle characteristics were then examined.

### Comparative Example 1

A non-electrolytic copper plating was carried out on silicon particles in an average size of 60 nm in the manner as described in Example 3. The copper-plated silicon particles were then treated with heat at 700° C. for 1 hour under an argon atmosphere. 0.5 g of the heat-treated silicon particles, 4.5 g of natural graphite, 0.25 g of conductive agent, 7.5 g of 0.1 wt. % aqueous CMC solution and 0.25 g of 40 wt. % aqueous SBR solution as a binder were mixed to obtain a slurry. The viscosity of the slurry was adjusted to 1000 centi-poise, at which the slurry was easily coated on a copper foil, and the slurry was then stirred with a mixer at 3000 rpm for 15 minutes. The slurry was then coated on 100 μm thick copper foil with the thickness of 10 μm with a doctor blade method, to produce an anode. Using the prepared anode, a battery were assembled in the manner as described in Example 1.

### Comparative Example 2

2.1 g of natural graphite, 0.1 g of carbon black as a conductive agent, and 5 g of 0.1 wt. % aqueous CMC solution as a binder were mixed to obtain a slurry. The viscosity of the slurry was adjusted to 1000 centi-poise, at which the slurry was easily coated on a copper foil, and the slurry was then stirred with a mixer at 3000 rpm for 15 minutes. The slurry was then coated on 100 μm thick copper foil with the thickness of 10 μm with a doctor blade method, to produce a graphite anode. This anode was cut into a predetermined size (e.g., 3×4 cm), and dried in a vacuum oven at 80° C. for 24 hours. A battery was assembled using the prepared anode in the manner as described in Example 1, and its charge and discharge characteristics, and cycle characteristics were then examined.

Experimental Results

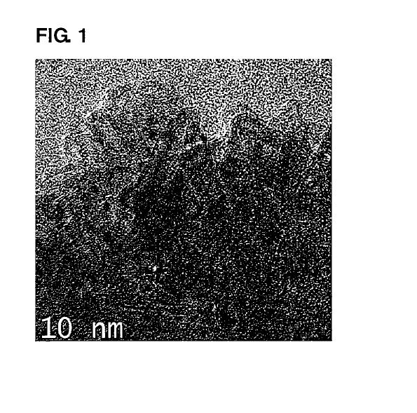

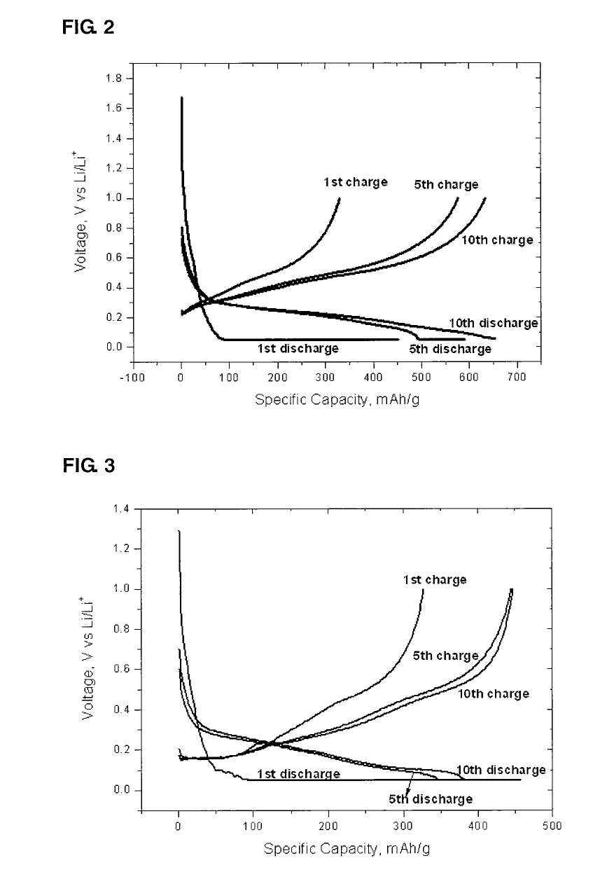

FIG. 1 shows a transmission electron microscopic (TEM) image of carbon nanotube which was formed on the surface of the silicon-copper alloy particle prepared in Example 1. FIG. 2 is a curve showing charge and discharge characteristics of the battery prepared in Example 1, experimental results for which were obtained at the current density of 0.25 mA/cm² in the potential range of 0.05 to 1.0 V vs Li/Li⁺. Referring to FIG. 2, the initial charge and discharge capacities were 330 mAh/g and 450 mAh/g, respectively, and thus, charge and discharge efficiency was 73.3%. At 5^{th} cycle, charge and discharge capacities were increased to 576 mAh/g and 590 mAh/g, respectively. At 10^{th} cycle, charge and discharge capacities were increased to 633 mAh/g and 657 mAh/g, respectively, resulting in increase of charge and discharge efficiency to 96.3%.

FIG. 3 is a curve showing charge and discharge characteristics of the initial ten cycles of the battery prepared in Example 2, experimental conditions for which were the same as those specified in regard to FIG. 2. The initial charge and discharge capacities were 327 mAh/g and 400 mAh/g, respectively, and the charge and discharge efficiency was 81.2%. At 5^{th} and 10^{th} cycles, the charge and discharge capacities were identically 447 mAh/g and 456 mAh/g, respectively. It was observed that the capacity was increased compared with that of initial cycle, and charge and discharge efficiency was 98%.

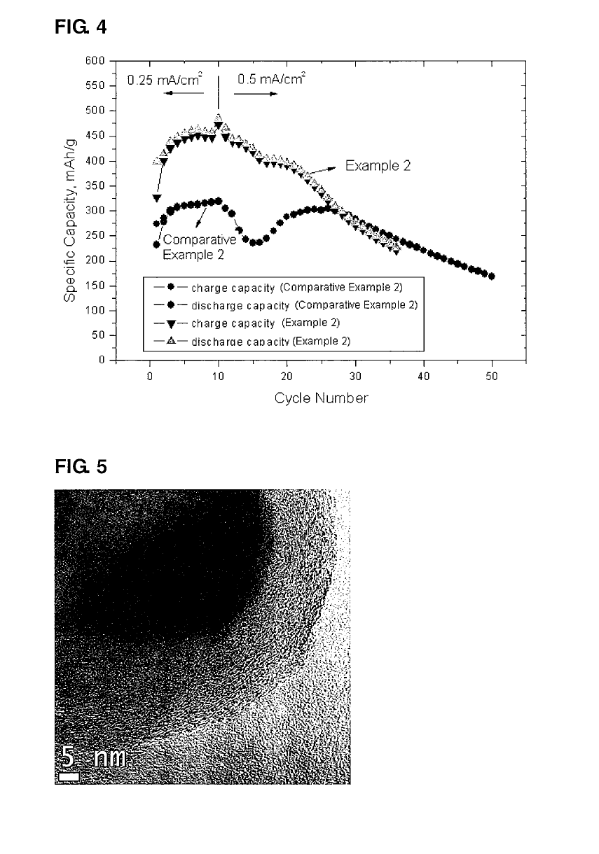

FIG. 4 is a graph for the comparison of cycle characteristics of the batteries prepared in Example 2 and Comparative Example 2. For the battery of Example 2, experimental results were obtained for initial 10 cycles at the current density of 0.25 mA/cm² in the potential range of 0.05 to 1.0 V vs Li/Li⁺, and for succeeding cycles at the current density of 0.5 mA/cm² in the same potential range. Charge and discharge capacities were tended to be continuously increased until initial 10 cycles, and then decreased. It is understood that the lithium metal electrode used as a counter electrode was deteriorated as shown in Comparative Example 2, as well as deterioration of the silicon electrode. However, the charge and discharge capacities of the battery of Example 2 were increased to 150 mAh/g on the average compared to those of the battery of Comparative Example 2.

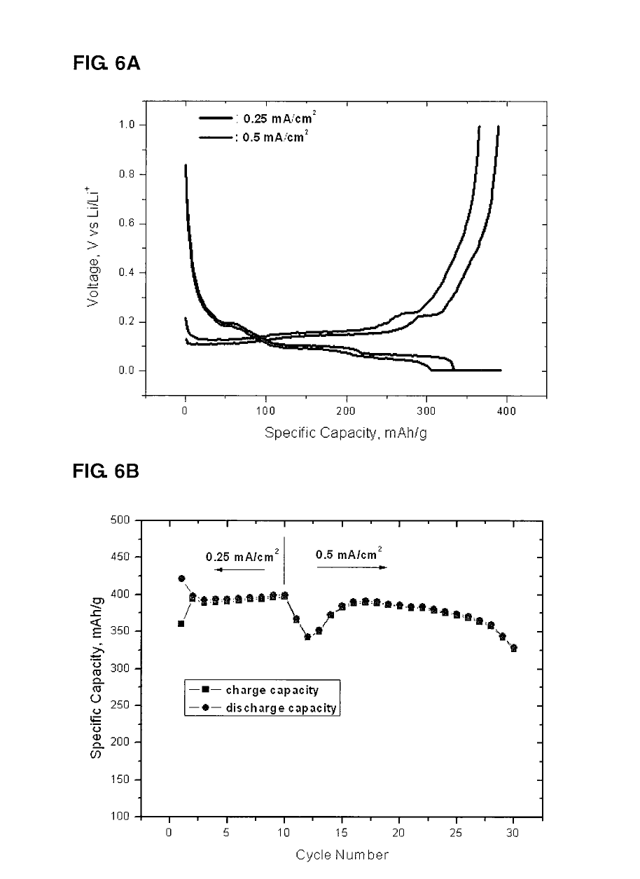

FIG. 5 shows a TEM image of the surface structure of silicon-copper composite particles prepared in Example 3. FIG. 6a is a curve showing the charge and discharge characteristics of the battery prepared in Example 3, experimental results for which were obtained at the current densities of 0.25 mA/cm² and 0.5 mA/cm², respectively, in the potential range of 0.005 to 1.0 V vs Li/Li⁺. It was discovered that charge and discharge capacities were 398 mAh/g and 400 mAh/g, respectively, at the current density of 0.25 mA/cm², and 368 mAh/g and 370 mAh/g at the current density of 0.5 mA/cm². 99.5% of the efficiency was not dependent on the current density. FIG. 6b shows cycle characteristics of the battery prepared in Example 3, wherein initial 10 cycles were carried out at the current density of 0.25 mA/cm² in the potential range of 0.005 to 1.0 V vs Li/Li⁺, followed by at the current density of 0.5 mA/cm² in the same potential range. There was an exhibition of a stable cycle performance at the current density of 0.25 mA/cm² with no decrease in charge and discharge capacities depending on cycles. At the current density of 0.5 mA/cm², charge and discharge capacities were decreased and then increased to 375 mAh/g so that a relatively stable performance was observed until the 30^{th} cycle.

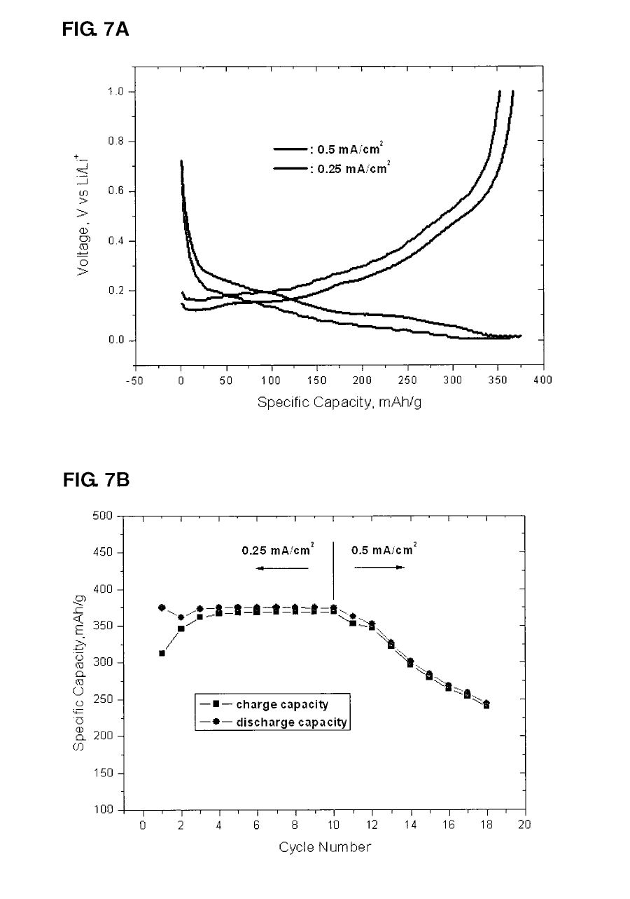

FIG. 7a is a curve showing charge and discharge characteristics of the battery prepared in Comparative Example 1, experimental results for which were obtained at the current densities of 0.25 mA/cm² and 0.5 mA/cm², respectively, in the potential range of 0.005 to 1.0 V vs Li/Li⁺. Charge and discharge capacities were 367 mAh/g and 374 mAh/g, respectively, at 0.25 mA/cm², and cycle efficiency was 98.1%. Charge and discharge capacities were 352 mAh/g and 362 mAh/g at 0.5 mA/cm², and cycle efficiency was 97.2%. FIG. 7b shows cycle characteristics of the battery prepared in Comparative Example 1, which exhibit a stable cycle performance without the decrease in charge and discharge capacities until initial 10 cycles, but exhibit a continuous decrease in charge and discharge capacities for further cycles.

As described above, the present invention can achieve several effects as follows:

First, an initial irreversible capacity can be decreased, and a mechanical stability is excellent with no volumetric change regardless of continuous charging and discharging reaction, and thus, the secondary battery of the present invention can have improved capacity, high rate charge and discharge characteristics, and cycle performance.

Second, the silicon/metal composite particles of the present invention are coated with carbon nanotubes, and thus, SEI membrane formation during initial charging can be prevented, resulting in retaining superior electric conductivity with stability. In addition, the carbon nanotube is not reactive with an electrolyte, the gas generation problem due to the decomposition of the electrolyte can be prevented.

Third, in the preparation method of an anode material comprising mixing the carbon nanotube-coated silicon/metal composite particles of the present invention with graphite, the conventional graphite anode preparation process can be applied, which allows an economic mass production of the anode material.

The foregoing embodiments and advantages are merely exemplary and are not to be construed as limiting the present disclosure. It should be understood by those skilled in the art of the present invention that various variations and other equivalents can be performed.

What is claimed is:

1. A carbon nanotube-coated silicon/metal composite particle, comprising a composite particle of silicon and metal; and a carbon nanotube coated on the surface of the composite particle of silicon and metal.

2. The carbon nanotube-coated silicon-copper composite particle according to claim 1, wherein the composite particle of silicon and metal is a particle of an alloy of silicon and metal.

3. The carbon nanotube-coated silicon/metal composite particle according to claim 1, wherein the composite particle of silicon and metal is a particle of silicon on which a metal is plated.

4. The carbon nanotube-coated silicon/metal composite particle according to claim 1, wherein the metal is at least one selected from the group consisting of phosphorous, magnesium, calcium, aluminum, titanium, copper, nickel, iron, chrome, manganese, cobalt, vanadium, tin, indium, zinc, gallium, germanium, zirconium, molybdenum and antimony.

5. The carbon nanotube-coated silicon/metal composite particle according to claim 1, wherein the ratio of silicon to metal in the composite particle of silicon and metal is in the range of 5:95 to 95:5.

6. The carbon nanotube-coated silicon/metal composite particle according to claim 1, wherein the carbon nanotube is grown by the metal in the composite particle of silicon and metal as a catalyst.

7. The carbon nanotube-coated silicon-copper composite particle according to claim 1, wherein a thickness of the carbon nanotube coated on the surface of the composite particle of silicon and metal is in the range of 1 to 20 nm.

8. A preparation method of the carbon nanotube-coated silicon/metal composite particle according to claim 1, comprising:
(a) preparing a composite particle of silicon and metal; and
(b) treating the composite particle of silicon and metal with heat under a mixed gas atmosphere of an inert gas and a hydrocarbon gas, to form a carbon nanotube on the surface of the composite particle of silicon and metal.

9. The method according to claim 8, wherein the composite particle of silicon and metal in step (a) is an alloy of silicon and metal prepared by mixing silicon particle and metal particles, followed by milling the resulting mixture.

10. The method according to claim 8, wherein the composite particle of silicon and metal in step (a) is a particle prepared by a electroless plating of the metal on the silicon particle.

11. The method according to claim 8, wherein the heat is treated in step (b) for 1 to 24 hours at 400 to 900°.

12. The method according to claim 8, wherein step (b) is carried out by heating at 350° for 3 hours, followed by raising heating temperature up to 600 to 900° at 1 to 10°/min.

13. The method according to claim 8, wherein the mixed gas is a mixture of argon or nitrogen gas with propylene or butylene gas.

14. The method according to claim 8, wherein the content of hydrocarbon gas is 5 to 50% by weight of total weight of the mixed gas.

15. An anode for a secondary battery comprising:
a collector; and
an anode active material comprising the carbon nanotube-coated silicon/metal composite particle according to claim 1.

16. The anode according to claim 15, wherein the anode active material further comprises graphite.

17. The anode according to claim 16, wherein the ratio of the carbon nanotube-coated silicon/metal composite particle to the graphite is 5:95 to 95:5 by weight.

18. A secondary battery comprising:
an anode, comprising a collector, and an anode active material comprising the carbon nanotube-coated silicon/copper composite particles according to claim 1, which is applied on at least one side of the collector;
a cathode; and
an electrolyte.

19. The secondary battery according to claim 18, wherein the carbon nanotube of the carbon nanotube-coated silicon/metal composite particle is not reactive with the electrolyte.
